(19) United States
(12) Patent Application Publication
(10) Pub. No.: US 2008/0133962 A1
(43) Pub. Date: Jun. 5, 2008

(54) METHOD AND SYSTEM TO HANDLE HARDWARE FAILURES IN CRITICAL SYSTEM COMMUNICATION PATHWAYS VIA CONCURRENT MAINTENANCE

(76) Inventors: Nicholas E. Bofferding, Austin, TX (US); Erlander Lo, Austin, TX (US); Kanisha Patel, Austin, TX (US); Timothy A. Smith, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/566,333

(22) Filed: Dec. 4, 2006

(51) Int. Cl. G06F 11/16; G06F 11/20

(52) U.S. Cl. 714/4; 714/24; 714/E11.054; 714/E11.071

(57) ABSTRACT

A method of preventing failed field replaceable units (FRUs) directly connected to an interprocessor bus or fabric from interfering with the operation of a computer system during concurrent maintenance operations. When a FRU fails a concurrent maintenance operation, the service processor stores identification information corresponding to the failed FRU in an alert fail registry or a hot add fail registry and reports the failure status to a user. When a user attempts to perform a new concurrent maintenance operation on a FRU, the service processor compares that FRU to the alert fail registry or the hot add fail registry. If a concurrent maintenance operation on the requested FRU would cause a system crash due to interference with the failed FRU, the service processor notifies the repair and verify application (which notifies the user) and prevents concurrent maintenance operations from occurring on the new FRU.

### CROSS-REFERENCE TO RELATED APPLICATIONS

The present application is related to the following co-pending U.S. patent application, filed on even date herewith, owned by the assignee hereof, and which is hereby incorporated herein by reference in its entirety: Ser. No. ______ (ATTY. DOCKET NO. AUS920060566US1), entitled “Dynamically Updating Alias Location Codes with Correct Location Codes During Concurrent Installation of a Component in a Computer System.”

### BACKGROUND OF THE INVENTION

1. Technical Field

The present invention relates in general to the field of computers and in particular to hardware concurrent maintenance. Still more particularly, the present invention relates to an improved method and system for installing, repairing, or removing hardware while a computer system is running.

2. Description of the Related Art

Operating errors often occur in computer hardware. These hardware-based operating errors typically result in a period of time, referred to as computer downtime, in which the computer is unavailable for use. For multi-user (or clustering computing environment) computers, such as mainframe computers, midrange computers, supercomputers, and network servers, the inability to use a particular computer may have a significant impact on the productivity of a large number of users, particularly if an error impacts mission-critical applications (e.g., when processing bank transactions). Multi-user computers are typically used around the clock, and as a result, it is critically important that these computers be accessible as much as possible.

A peripheral component interface (PCI) bus is a high speed interface between the processor of a computer and one or more slots used to host printed circuit boards (PCBs). PCBs typically control various hardware devices that are communicatively connected to the computer. The PCI hot plug specification permits individual slots on a PCI bus to be selectively powered off in order to permit cards to be removed and/or installed when a computer system is running.

Hardware concurrent maintenance is utilized to address the problems associated with computer downtime. Hardware concurrent maintenance is a process of performing maintenance on computer hardware, while the computer is running, thereby resulting in minimal impact to user accessibility. Conventional hardware concurrent maintenance implementations are provided by the PCI hot plug specification, which is implemented via a PCI bus. However, the PCI bus of a system typically handles communication between peripheral components and operates at a lower data transfer rate than the interprocessor bus or fabric, which enables one or more processor units at the core of a computer system to communicate rapidly. Conventional methods do not provide algorithms to ensure that a FRU that undergoes partial concurrent maintenance and is left in an intermediate state does not adversely affect the computer system if other concurrent maintenance operations are attempted. Consequently, an improved method and system for performing concurrent maintenance on hardware components connected to an interprocessor bus is needed.

### SUMMARY OF THE INVENTION

Disclosed is a method, system, and computer program product for preventing failed field replaceable units (FRUs) directly connected to an interprocessor bus from interfering with the operation of a computer system after a concurrent maintenance operation failure. The service processor is required to alert the POWER Hypervisor*™ of new resources during a concurrent maintenance operation in a step referred to as a “new hardware alert step”. When the POWER Hypervisor*™ fails to successfully process new resources, thereby failing the “new hardware alert step”, the service processor stores the resource ID (RID) of the failed FRU in an alert fail registry within the local memory of the service processor and reports the failure to the repair and verify (R&V) application. The R&V application is located within a hardware management console (HMC) that is connected to the computer via an external network.

When a FRU fails a hot add concurrent maintenance operation, where a hot add is defined as a procedure that electrically connects a new FRU to the interprocessor bus, the service processor stores identification information corresponding to the failed FRU in a hot add fail registry within the local memory of the service processor and reports the failure status to a user. The service processor compares the identifier (ID), also referred to as a location code, of a failed FRU to the identification information stored in the alert fail registry and determines whether the user should retry the concurrent maintenance operation on the failed FRU or attempt concurrent maintenance on another FRU. When a client queries the service processor for a FRU to perform a concurrent maintenance operation and the service processor returns an error or if a communication timeout occurs, the service processor prevents concurrent maintenance operations from occurring if a hot add concurrent maintenance operation might cause the computer to crash.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts a high level block diagram of an exemplary data processing system, as utilized in an embodiment of the present invention;

FIG. 2A is a high level logical flowchart of an exemplary method of fencing off any other FRU (other than that which failed) from being concurrently maintained according to an embodiment of the present invention;

FIG. 2B is a high level logical flowchart of an exemplary method of providing serialized recovery of a concurrent maintenance operation after a prior failure to interlock new resource discovery with the POWER Hypervisor*™, according to an embodiment of the present invention; and

FIG. 3 is a high level logical flowchart of an exemplary method of preventing a system crash caused by a concurrent maintenance hot add failure, in accordance with one embodiment of the invention.

### DETAILED DESCRIPTION OF AN ILLUSTRATIVE EMBODIMENT

The present invention provides a method, system, and computer program product for preventing failed field replaceable units (FRUs) from interfering with the operation of a computer system during concurrent maintenance operations. As utilized herein, a FRU is defined as a separate entity (e.g., a central electronics complex (CEC) entity) that can be replaced in a service action performed on the computer system. During a service action, a user can thus replace one or more single physical pieces of packaging (i.e., a FRU, or a package containing multiple smaller FRUs) to fix a particular problem.

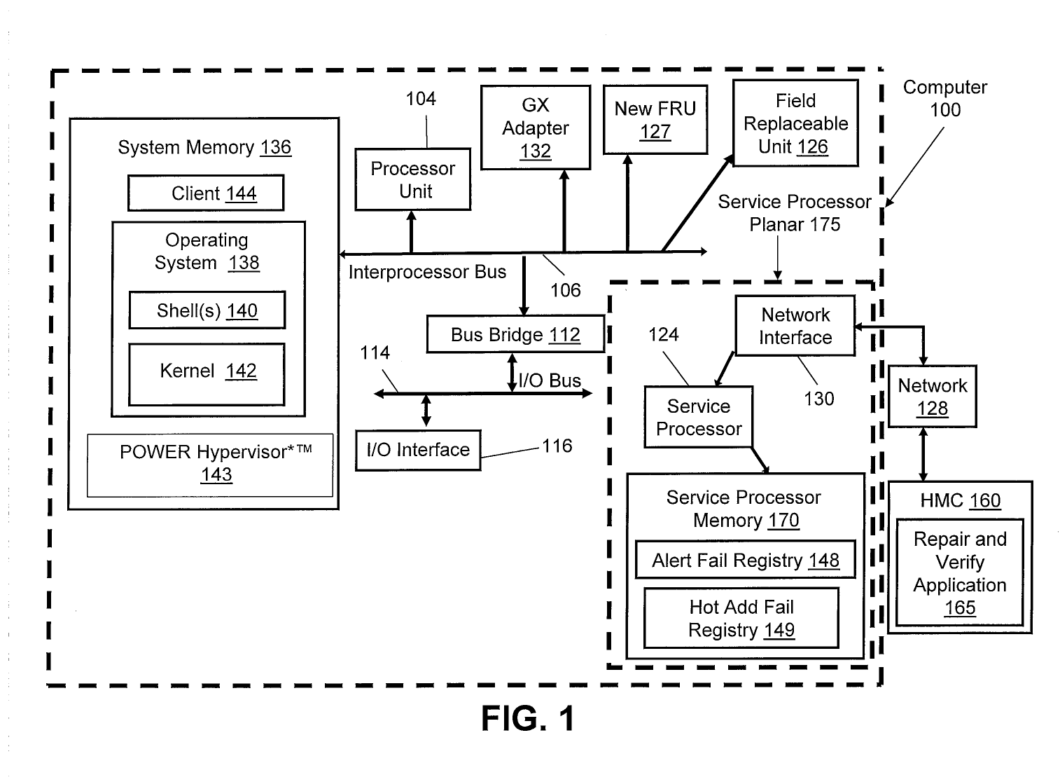

With reference now to FIG. 1, there is depicted a block diagram of an exemplary computer 100, with which the present invention may be utilized. Computer 100 includes processor unit 104 that is coupled to interprocessor bus 106. Interprocessor bus 106 is coupled via bus bridge 112 to Input/Output (I/O) bus 114. I/O interface 116 is coupled to I/O bus 114. I/O interface 116 affords communication with various I/O devices.

GX adapter 132 (also referred to as an I/O hub), is defined as a high-speed adapter that plugs directly into interprocessor bus 106. GX adapter 132 is one example of a FRU and can thus be hot added to interprocessor bus 106. According to the illustrative embodiment, FRU 126 and new FRU 127 are also coupled to interprocessor bus 106. FRU 126 is an FRU that has failed, herein after referred to as failed FRU 126.

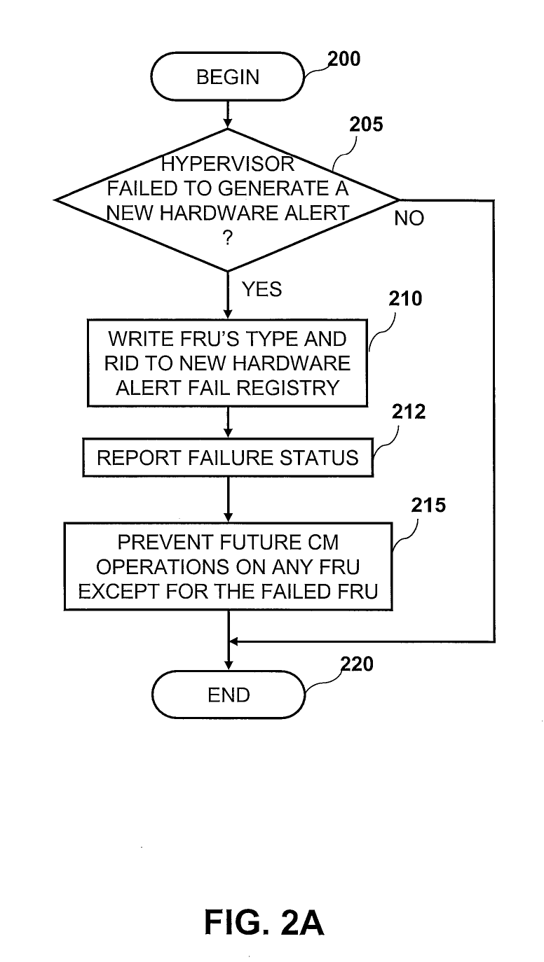

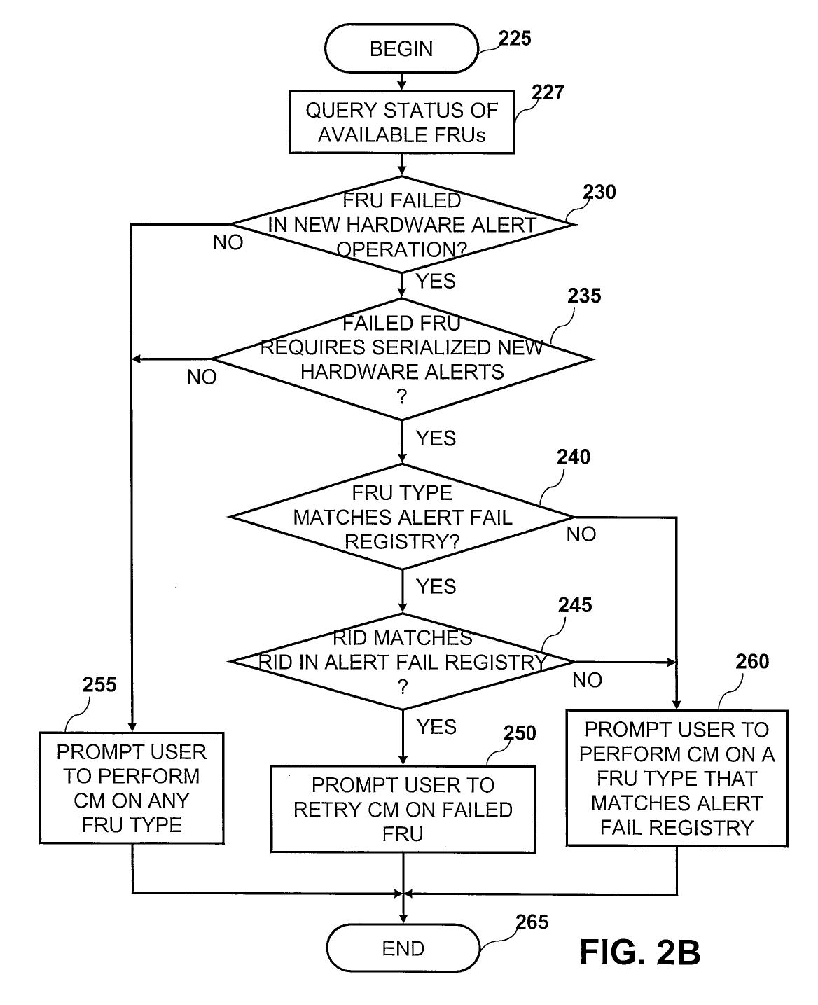

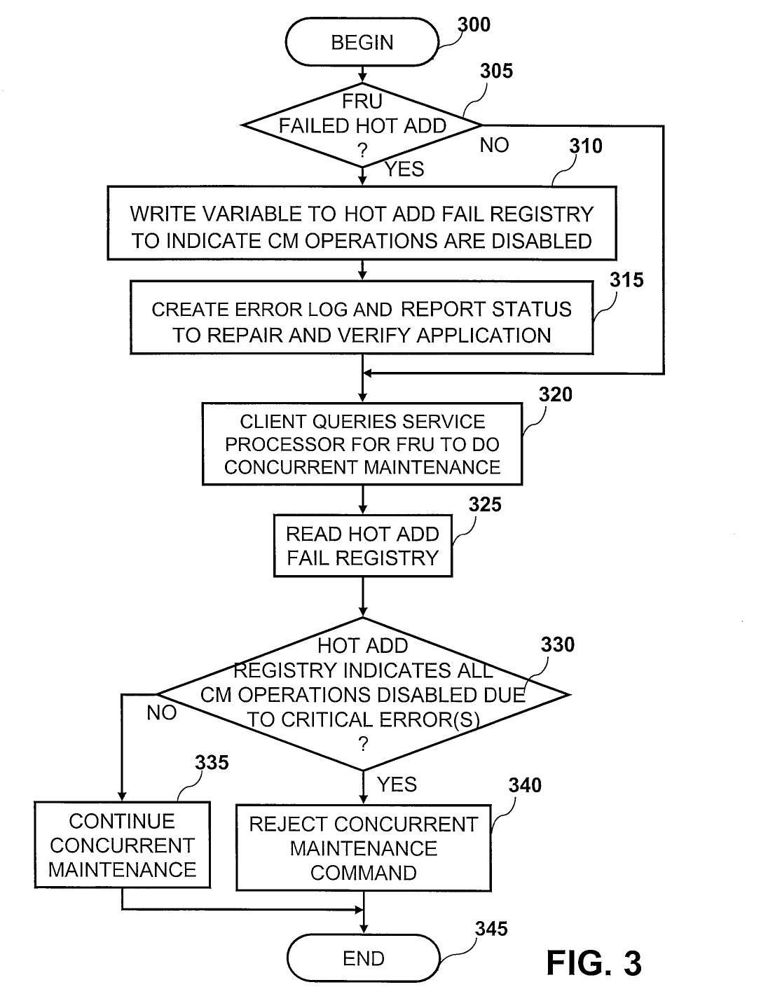

Computer 100 includes a service processor planar 175, which includes network interface 130, service processor 124, and service processor memory 170. Computer 100 is able to communicate with hardware management console (HMC) 160 via network 128 using network interface 130, which is coupled to service processor 124. HMC 160 includes a repair and verify (R&V) application 165. Service processor 124 and repair and verify application 165 perform the processes illustrated in FIGS. 2 and 3, which are discussed below. Network 128 may be an external network such as the Internet, or an internal network such as an Ethernet or a Virtual Private Network (VPN).

As illustrated, service processor 124 is not coupled directly to interprocessor bus 106, but instead utilizes a hardware mailbox (not shown) to communicate with POWER Hypervisor*™ 143. In such an embodiment, computer 100 may be referred to as a POWER5**™ computer system. POWER Hypervisor*™ and POWER5**™ are trademarks of International Business Machines (IBM) corporation. Service processor memory 170 includes an alert fail registry 148 and a hot add fail registry 149, which act as local storage locations for service processor 124.

System memory 136 is defined as a lowest level of volatile memory in computer 100. This volatile memory may include additional higher levels of volatile memory (not shown), including, but not limited to, cache memory and buffers. Code that populates system memory 136 includes one or more clients 144 and operating system (OS) 138 which runs on top of POWER Hypervisor*™ 143.

OS 138 includes shell 140, for providing transparent user access to resources such as client 144. Generally, shell 140 (as it is called in UNIX®) is a program that provides an interpreter and an interface between the user and operating system 138. As depicted, OS 138 also includes kernel 142, which includes lower levels of functionality for OS 138. POWER Hypervisor*™ 143 partitions the tasks performed by processor unit 104, and thus may also be referred to as a partition POWER Hypervisor*™. POWER Hypervisor*™ 143 also performs concurrent resource discovery scans during concurrent maintenance operations to determine if new FRUs 127 have been added to or removed from computer 100.

The hardware elements depicted in computer 100 are not intended to be exhaustive, but rather represent and/or highlight certain components that may be utilized to practice the present invention. Computer 100 may include alternate configuration elements, and these and other variations are intended to be within the spirit and scope of the present invention.

With reference now to FIG. 2A, there is illustrated a high level logical flowchart of an exemplary method of fencing off additional concurrent maintenance operations to other FRUs 127 if a failed FRU 126 requires serialized new hardware alert steps, as used in an embodiment of the present invention. The process begins at block 200 in response to a user of HMC 160 initiating concurrent maintenance on computer 100. A determination is made, as depicted in block 205, whether software within service processor 124 has failed to generate a new hardware alert to notify POWER Hypervisor* 143 during a concurrent maintenance operation. A new hardware alert failure is supposed to be generated when new FRU 127 is connected to interprocessor bus 106 and is detected when POWER Hypervisor* 143 sends an error message or when service processor 124 detects a communication timeout.

A new hardware alert is defined as a message service processor 124 sends to POWER Hypervisor* 143 in response to the detection of new hardware inserted into computer 100 by a user performing concurrent maintenance. When POWER Hypervisor*™ 143 receives that message, POWER Hypervisor*™ 143 attempts to discover the new hardware and update its view of the system configuration. If POWER Hypervisor*™ 143 fails to discover the new hardware due to software or hardware problem, POWER Hypervisor*™ 143 returns an error response to service processor 124. If a user attempts a subsequent concurrent maintenance operation on a second FRU (e.g., new FRU 127) on the same platform, POWER Hypervisor*™ 143 may discover both new FRU 127 and first failed FRU 126. If POWER Hypervisor*™ 143 inadvertently attempts to communicate with first (failed) FRU 126, the communication attempt may cause a system crash.

In response to a determination that a concurrent maintenance operation has not failed to notify POWER Hypervisor*™ 143 of new hardware for new FRU 127, the process terminates at block 220 and concurrent maintenance is allowed to continue normally. If POWER Hypervisor*™ 143 fails to complete the new hardware alert step or service processor 124 detects a communication timeout, service processor 124 writes the type of FRU 126 and the resource identifier (RID) to alert fail registry 148, as shown in block 210. Repair and verify application 165 reports the alert failure to a user of HMC 160, as depicted at block 212. At block 215, assuming the failed FRU 126 requires serialized new hardware alerts, service processor 124 prevents any future concurrent maintenance operations on any FRU except for the failed FRU 126. The processes illustrated by blocks 205 through 215 thus selectively fence off additional concurrent maintenance operations to other FRUs 127 if a failed FRU 126 requires serialized new hardware alert steps.

With reference now to FIG. 2B, there is illustrated a high level logical flowchart of an exemplary method of serializing the concurrent resource discovery by a POWER Hypervisor*™, according to an embodiment of the present invention. The process begins at block 225 in response to repair and verify application 165 performing a query to determine which FRUs are available for a concurrent maintenance operation. Service processor 124 performs a query to determine which FRUs in computer 100 are available for a concurrent maintenance operation, as shown in block 227. A determination is made at block 230 whether alert fail registry 148 indicates that FRU 126 failed during a new hardware alert operation of a concurrent maintenance operation. If failed FRU 126 did not fail during a new hardware alert operation, repair and verify application 165 prompts a user of HMC 160 to perform concurrent maintenance on any FRU type, regardless of whether the FRU type matches alert fail registry 148, as shown in block 255, and the process terminates at block 265, where alert fail registry 148 is cleared. If failed FRU 126 failed in the new hardware alert step during a concurrent maintenance operation, a determination is made whether the failed FRU 126 requires serialized new hardware alerts, as depicted in block 235.

In response to a determination that the failed FRU 126 does not require serialized new hardware alerts, repair and verify application 165 prompts a user of HMC 160 to perform concurrent maintenance on any FRU type, regardless of whether the FRU type matches alert fail registry 148, as shown in block 255, and the process terminates at block 265, where alert fail registry 148 is cleared. If the failed FRU 126 requires serialized new hardware alerts, a determination is made whether the type of failed FRU 126 being queried matches the FRU type stored in alert fail registry 148, as depicted in block 240. If the type of failed FRU 126 being queried does not match the FRU type stored in alert fail registry 148, repair and verify application 165 prompts a user of HMC 160 to perform concurrent maintenance on a FRU with a FRU type that matches alert fail registry 148, as shown in block 260, and the process terminates at block 265, where alert fail registry 148 is cleared.

In response to a determination that the type of failed FRU 126 being queried matches the FRU type stored in alert fail registry 148, a decision is made whether the RID of failed FRU 126 matches the RID stored in alert fail registry 148, as shown in block 245. If the RID of failed FRU 126 does not match the RID stored in alert fail registry 148, repair and verify application 165 prompts a user of HMC 160 to perform concurrent maintenance on a FRU with a FRU type that matches alert fail registry 148, as shown in block 260, and the process terminates at block 265. If the RID of failed FRU 126 matches the RID stored in alert fail registry 148, repair and verify application 165 prompts a user of HMC 160 to retry the concurrent maintenance operation according to the preserved checkpoint of the current failed FRU 126, as depicted in block 250. The process then terminates, as shown in block 265 and alert fail registry 148 is cleared if the retried concurrent maintenance operation succeeds. A checkpoint is defined as a token associated with a particular FRU that indicates which concurrent maintenance step should be performed on that particular FRU.

Turning now to FIG. 3, there is illustrated a high level logical flowchart of an exemplary method of preventing a system crash caused by a concurrent maintenance hot add failure, according to an embodiment of the present invention. The process begins at block 300 in response to a user of HMC 160 initiating repair and verify application 165. A determination is made whether failed FRU 126 fails a hot add operation of a concurrent maintenance operation, as shown in block 305. If failed FRU 126 does not fail a hot add operation, the process proceeds to block 320, which is discussed below.

In response to a determination that failed FRU 126 fails a hot add operation, service processor 124 writes a variable to hot add fail registry 149 in order to indicate that all concurrent maintenance operations are disabled due to the possibility of a critical error, as shown in block 310. Service processor 124 creates an error log and reports the hot add failure status to repair and verify application 165, as depicted in block 315.

Client 144 queries service processor 124 to identify a FRU that is eligible for a concurrent maintenance operation, as shown in block 320. Service processor 124 reads a key corresponding to the queried failed FRU 126 from hot add fail registry 149, as depicted in block 325.

A determination is made at block 330 whether hot add fail registry 149 contains a variable stored by service processor 124 to indicate that all concurrent maintenance operations are currently disabled due to one or more critical errors. If hot add fail registry 149 does not indicate that all concurrent maintenance operations are currently disabled due to one or more critical errors, the concurrent maintenance operation is allowed to continue, as shown in block 335, and the process terminates at block 345. In response to a determination that hot add fail registry 149 indicates that all concurrent maintenance operations are currently disabled due to one or more critical errors, service processor 124 rejects the concurrent maintenance command from user as shown in block 340, and the process terminates at block 345, such that the concurrent maintenance operation does not occur.

The present invention thus prevents computer 100 from crashing due to a hot add failure during a concurrent maintenance operation by blocking conventional FRU recovery procedures that would endanger the system. Furthermore, the present invention prevents POWER Hypervisor*™ 143 from communicating with a FRU that failed to complete the new hardware alert step in a concurrent maintenance operation until concurrent maintenance on the failed FRU succeeds.

It is understood that the use herein of specific names are for example only and not meant to imply any limitations on the invention. The invention may thus be implemented with different nomenclature/terminology and associated functionality utilized to describe the above devices/utility, etc., without limitation. In the flow charts (FIGS. 2-3) above, while the process steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

While an illustrative embodiment of the present invention has been described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as thumb drives, floppy disks, hard drives, CD ROMs, DVDs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. In a data processing system, a method comprising:
when a field replaceable unit (FRU) connected to an interprocessor bus fails a concurrent maintenance(CM) operation, updating a CM variable to a first value indicating that CM operations are disabled for the data processing system; and
rejecting subsequent CM requests when the CM variable is set to the first value.

2. The method of claim 1, wherein said updating the CM variable further comprises:
writing the CM variable to a CM (hot add) failure registry, which variable indicates that all concurrent maintenance operations are disabled when said FRU fails a hot add operation during said concurrent maintenance operation;
generating an error log; and
reporting the error log to a repair and verify application within a hardware management console (HMC).

3. The method of claim 1, further comprising:
receiving a client query at a service processor for a subsequent CM operation;
checking a current value of the CM variable within the CM failure registry;
rejecting the subsequent CM operation from the client when the current value of the CM variable is the first value; and
enabling the CM operation when the current value of the CM variable is not the first value.

4. The method of claim 1, further comprising:
when the FRU connected to the interprocessor bus does not complete a specific portion of a concurrent maintenance (CM) operation, storing a resource identification (RID) corresponding to the FRU in a registry; and
when the FRU is a first sequential FRU on which a CM operation is performed and said FRU requires serialization of the completion of the specific portion of the CM operation relative to other FRUs for which subsequent CM operations are requested, preventing a completion of a subsequent CM operation for one of the other FRUs until the CM operation of the first sequential FRU is completed.

5. The method of claim 4, wherein the specific portion of the CM operation is a new hardware alert and the registry is an alert failure registry, said method further comprising:
storing an FRU type of the first sequential FRU within the new hardware alert failure registry; and
reporting a failure status to a repair and verify application within a hardware management console (HMC).

6. The method of claim 5, wherein when the CM operation of the other FRU is requested following a failure of the specific portion of the CM operation from completing, said method comprises:
comparing the FRU type of the other FRU with a previously stored FRU type of said failed FRU within the alert failure registry; and
when the FRU type of the other FRU does not match the previously stored FRU type, prompting for a retry of said subsequent CM operation on an FRU having the FRU type that matches said previously stored FRU type;

7. The method of claim 6, further comprising:
comparing the RED of the other FRU with a previously stored RID within the alert failure registry;
when said FRU fails to complete said new hardware alert step and resource identifier (RID) information of said other FRU does not match the previously stored RID information, prompting for a retry of said concurrent maintenance operation on the FRU that failed to complete the new hardware alert step; and
when said FRU fails to complete said new hardware alert step and said RID information of said subsequent FRU matches said RID information stored in said alert fail registry, initiating a query of a plurality of FRUs within said data processing system to determine which FRUs are eligible for said subsequent CM operation.

8. The method of claim 4, further comprising prompting said user to perform concurrent maintenance on a FRU having a FRU type other than said FRU type of said failed FRU in response to a determination that said failed FRU does not require serialized new hardware alerts.

9. A data processing system comprising:
a processor unit;
an interprocessor bus;
at least one field replaceable unit (FRU) coupled to said interprocessor bus;
a system memory communicatively connected to said processor via said interprocessor bus;
a network interface coupled to a service processor that provides means for communicatively connecting said data processing system to a hardware management console (HMC) via an external network;
means, when a field replaceable unit (FRU) connected to an interprocessor bus fails a concurrent maintenance (CM) operation, for updating a CM variable to a first value indicating that CM operations are disabled for the data processing system; and
means for rejecting subsequent CM requests when the CM variable is set to the first value.

10. The data processing system of claim 9, further comprising:
a hot add fail registry within a service processor memory that stores FRU identification variables and an error log that identifies any FRU that fails a hot add operation during said CM operation;
wherein said means for updating the CM variable further comprises:
means for writing the CM variable to a CM (hot add) failure registry, which variable indicates that all concurrent maintenance operations are disabled when said FRU fails a hot add operation during said concurrent maintenance operation;
means for generating an error log; and
means for reporting the error log to a repair and verify application within a hardware management console (HMC).

11. The data processing system of claim 9, further comprising:
means for receiving a client query at a service processor for a subsequent CM operation;
means for checking a current value of the CM variable within the CM failure registry;
means for rejecting the subsequent CM operation from the client when the current value of the CM variable is the first value; and
means for enabling the CM operation when the current value of the CM variable is not the first value.

12. The data processing system of claim 1, further comprising:
means, when the FRU connected to the interprocessor bus does not complete a specific portion of a concurrent maintenance (CM) operation, for storing a resource identification (RID) corresponding to the FRU in a registry; and
when the FRU is a first sequential FRU on which a CM operation is performed and said FRU requires serialization of the completion of the specific portion of the CM operation relative to other FRUs for which subsequent CM operations are requested, preventing a completion of a subsequent CM operation for one of the other FRUs until the CM operation of the first sequential FRU is completed.

13. The data processing system of claim 12, further comprising:
an alert fail registry within said service processor memory that stores FRU type and identification information corresponding to any FRU that fails to complete a new hardware alert step during said CM operation, wherein the specific portion of the CM operation is the new hardware alert and the registry is an alert failure registry;
means for storing an FRU type of the first sequential FRU within the new hardware alert failure registry; and
means for reporting a failure status to a repair and verify application within a hardware management console (HMC).

14. The data processing system of claim 13, wherein when the CM operation of the other FRU is requested following a failure of the specific portion of the CM operation from completing, said system comprises:
means for comparing the FRU type of the other FRU with a previously stored FRU type of said failed FRU within the alert failure registry; and
means, when the FRU type of the other FRU does not match the previously stored FRU type, for prompting for a retry of said subsequent CM operation on an FRU having the FRU type that matches said previously stored FRU type;

15. The data processing system of claim 14, further comprising:
means for comparing the RID of the other FRU with a previously stored RID within the alert failure registry;
means, when said FRU fails to complete said new hardware alert step and resource identifier (RID) information of said other FRU does not match the previously stored RID information, for prompting for a retry of said concurrent maintenance operation on the FRU that failed to complete the new hardware alert step; and
means, when said FRU fails to complete said new hardware alert step and said RID information of said subsequent FRU matches said RID information stored in said alert fail registry, for initiating a query of a plurality of FRUs within said data processing system to determine which FRUs are eligible for said subsequent CM operation.

16. The data processing system of claim 12, further comprising means for prompting for initiation of a concurrent maintenance on a FRU having a FRU type other than said FRU type of said failed FRU in response to a determination that said failed FRU does not require serialized new hardware alerts.

17. A computer program product comprising:
a computer readable medium; and
program code on said computer readable medium that that when executed provides the functions of:
when a field replaceable unit (FRU) connected to an interprocessor bus fails a concurrent maintenance (CM) operation, updating a CM variable to a first value indicating that CM operations are disabled for the data processing system, wherein said updating the CM variable further comprises:
writing the CM variable to a CM (hot add) failure registry, which variable indicates that all concurrent maintenance operations are disabled when said FRU fails a hot add operation during said concurrent maintenance operation;
generating an error log; and
reporting the error log to a repair and verify application within a hardware management console (HMC); and
rejecting subsequent CM requests when the CM variable is set to the first value.

18. The computer program product of claim 17, further comprising code for:
receiving a client query at a service processor for a subsequent CM operation;
checking a current value of the CM variable within the CM failure registry;
rejecting the subsequent CM operation from the client when the current value of the CM variable is the first value; and
enabling the CM operation when the current value of the CM variable is not the first value.

19. The computer program product of claim 17, said program code further comprising code for:
when the FRU connected to the interprocessor bus does not complete a specific portion of a concurrent maintenance (CM) operation, storing a resource identification (RID) corresponding to the FRU in a registry;
when the FRU is a first sequential FRU on which a CM operation is performed and said FRU requires serialization of the completion of the specific portion of the CM operation relative to other FRUs for which subsequent CM operations are requested, preventing a completion of a subsequent CM operation for one of the other FRUs until the CM operation of the first sequential FRU is completed;
wherein the specific portion of the CM operation is a new hardware alert and the registry is an alert failure registry, said program code further comprising code for:
storing an FRU type of the first sequential FRU within the new hardware alert failure registry; and
reporting a failure status to a repair and verify application within a hardware management console (HMC); and
prompting for implementation of a concurrent maintenance on an FRU having a FRU type other than said FRU type of said failed FRU in response to a determination that said failed FRU does not require serialized new hardware alerts.

20. The computer program product of claim 19, wherein when the CM operation of the other FRU is requested following a failure of the specific portion of the CM operation from completing, said program code comprises code for:
comparing the FRU type of the other FRU with a previously stored FRU type of said failed FRU within the alert failure registry; and
when the FRU type of the other FRU does not match the previously stored FRU type, prompting for a retry of said subsequent CM operation on an FRU having the FRU type that matches said previously stored FRU type;
comparing the RID of the other FRU with a previously stored RID within the alert failure registry;
when said FRU fails to complete said new hardware alert step and resource identifier (RID) information of said other FRU does not match the previously stored RID information, prompting for a retry of said concurrent maintenance operation on the FRU that failed to complete the new hardware alert step; and
when said FRU fails to complete said new hardware alert step and said RID information of said subsequent FRU matches said RID information stored in said alert fail registry, initiating a query of a plurality of FRUs within said data processing system to determine which FRUs are eligible for said subsequent CM operation.
